(19) United States
(12) Patent Application Publication
(10) Pub. No.: US 2026/0015460 A1
(43) Pub. Date: Jan. 15, 2026

(54) EPOXY AMINE (METH)ACRYLATE HYDROXY URETHANE RESIN COMPOSITION

(71) Applicant: Spider Resin Limited, Buckinghamshire (GB)

(72) Inventor: Bernard Barthel, Chatou (FR)

(21) Appl. No.: 18/840,708

(22) PCT Filed: Jul. 6, 2022
(86) PCT No.: PCT/GB2022/051729

§ 371 Date: Aug. 22, 2024

(30) Foreign Application Priority Data
Feb. 28, 2022 (GB) 2202769.2

(51) Int. Cl. C08G 71/04

(52) U.S. Cl. CPC C08G 71/04

(57) ABSTRACT

A two-part epoxy resin composition is provided comprising: a first resin part comprising a modified hydroxy alkyl urethane and an epoxy component; and a second resin part comprising an amine component; wherein the modified hydroxy alkyl urethane is formed by a reaction between a (meth)acrylate monomer or oligomer and a hydroxy alkyl urethane having the formula: (Formula (I)); where: R¹ is an amine residue; and R² and R³ are the same or different and are selected from the group consisting of H, alkyl, and hydroxyalkyl.

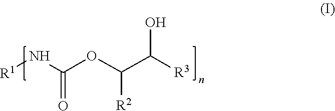

### FIELD OF THE INVENTION

The present invention relates to a modified hydroxy alkyl urethane, which is preferably formed without any intermediate isocyanate compounds. The invention further relates to an epoxy amine hydroxy urethane composition, of the type which is able to be used in paints, composites, potting compounds, and adhesives. The invention further relates to a method of production of said composition.

### BACKGROUND

It is known in the art that epoxy resins react with amines as hardeners, forming a three-dimensional network according to the following reaction scheme:

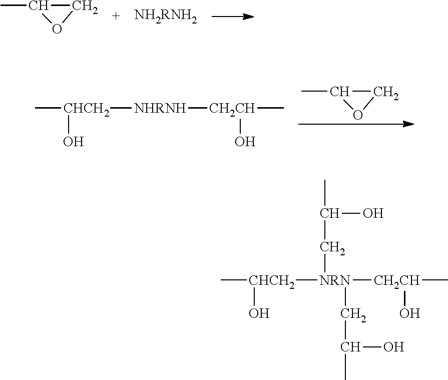

This reaction can be accelerated by the addition of accelerators. Such accelerators have a number of disadvantages. For example, trisdimethylaminomethylphenol (Ancamine K-54 from Evonik (RTM)) or 1.2 aminoethylpiperazine, also known as AEP (Accelerator 399 from Huntsman (RTM)) are sensitive to light. Acids such as salicylic acid, paratoluene sulfonic acid, or boron trifluoride are also accelerators, but have a poor toxicological and environmental profile.

Commonly used amines are aliphatic, cycloaliphatic, polyoxypropylene diamine, amines. Polyamides, polyamino amides and phenalkamines may be used, as well as aromatic amines, mercaptans, and anhydrides.

U.S. Pat. No. 4,051,195A discloses a composition made of a mixture of epoxy resin and acrylate or methacrylate esters. This composition reacts quickly at low temperature when mixed with hardeners of the aliphatic amine type. This composition is used in the manufacture of paints and adhesives.

The amine acrylate reaction responds to a Michael reaction in which the C═C bond reacts with the NH2 bond according to the following scheme.

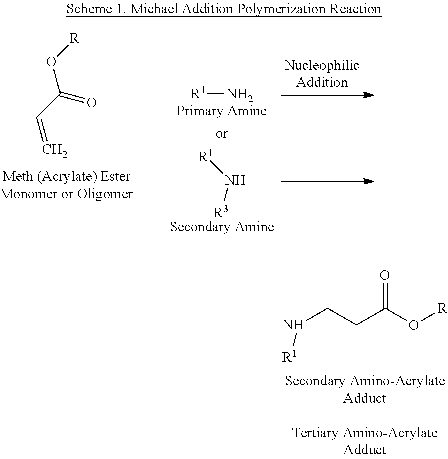

U.S. Pat. No. 5,830,987A discloses a composition made from the hydroxylated polyacrylate reaction on an amine. The mixture reacts very quickly and is used for the manufacture or composite materials containing glass fibers.

WO2005010104A2 discloses a coating composition in a mold having covalent compatibility and which is used with an epoxy. This composition undergoes a Michael addition when mixed with an unsaturated polyester resin.

U.S. Pat. No. 6,706,821B1 describes a composition utilising a Michael reaction of an acrylate on a polyolefin having an amino terminus.

U.S. Pat. No. 7,989,553B2 discloses a hydroxy alkyl urethane modifier having a molecular weight of 374 and a viscosity at 50° C. of 27 Pa·s. The consumption of the carbonate function is monitored by infra-red spectroscopy (wavelength 1800 cm⁻¹ replaced by the urethane function). The hydroxy alkyl urethane modifier is then diluted with isophorone diamine until an AEHW is achieved of 59+/−2.

The compositions in the art are problematic due to their method of formation. The amine epoxy acrylate reaction is highly reactive, being highly exothermic. The resulting compound also exhibits a high degree of three-dimensional networking, resulting in a high rigidity. Coupled with the presence of an epoxy resin containing one or both of bisphenol A and bisphenol F, the measured Shore D hardness is rarely less than 70.

### SUMMARY OF THE INVENTION

It is therefore an object of the invention to develop a less reactive and less exothermic method of creating a suitable composition, with the composition itself being both flexible and hard. Ideally, the measured hardness should be in the range of Shore A 20 to Shore D 85.

According to a first aspect of the invention, there is provided a two-part epoxy resin composition comprising: a first resin part comprising a modified hydroxy alkyl urethane and an epoxy component; and a second resin part comprising an amine component; wherein the modified hydroxy alkyl urethane is formed by a reaction between a (meth)acrylate monomer or oligomer and a hydroxy alkyl urethane having the formula:

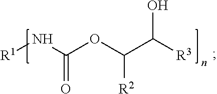

where: R¹ is an amine residue; and R² and R³ are the same or different and are selected from the group consisting of H, alkyl, and hydroxyalkyl. Within the industry, the first and second resin parts are commonly referred to as part A and part B of the two-part epoxy resin composition, respectively. Part B components are often also referred to as activators, catalysts, or hardeners.

The composition of the present invention can be used in a wide variety of coating and adhesive contexts to provide improved chemical and mechanical properties, such as abrasion resistance, whilst avoiding the production of isocyanate, which is an irritant to the skin and mucous membranes, and can cause difficulty breathing. This composition is therefore much safer than those used in the art, and the uramine activator requirement is eliminated. The first resin part also meets the REACH (Registration, Evaluation, Authorisation and Restriction of Chemicals-Reg (EC) No. 1272/2008) definition of a polymer, which exempts them from REACH registration and evaluation, due to the high molecular weight. This creates a product which has reduced risk to the user when compared with existing epoxy resin compositions comprising monomers.

Preferably, the (meth)acrylate monomer or oligomer may have a (meth)acrylate backbone residue of a bi- or poly-(meth)acrylate.

Optionally, R¹ may be selected from the group comprising: alkyl; cycloalkyl; alkylaryl; polyether; or oxyalkylene.

The epoxy component may comprise at least two terminal glycidyl groups.

Preferably, the modified hydroxy alkyl urethane may have an epoxy equivalent weight of between 100 and 2000.

Optionally, the epoxy component may be an epoxy resin or an epoxy with epoxy diluents.

The epoxy component may comprise an epoxy resin from the group: diglycidyl ether epoxy resin of bisphenol A; diglycidyl ether epoxy resin of bisphenol F; diglycidyl ether epoxy resin of bisphenol from cardanol; diglycidyl ether epoxy resin of hydrogenated bisphenol A; polyglycidyl ether resins; novolacs; hydrogenated novolacs; or any cycloaliphatic polyglycidyl ether resins; or combinations thereof.

Optionally, the epoxy component may comprise a pentaerythritol polyglycidyl ether.

Preferably, the amine component may comprise an amine having an amine hydrogen equivalent weight, based on solids, of less than 150.

Optionally, the (meth)acrylate monomer or oligomer may be introduced in an amount of 15 to 60% by weight of the hydroxy alkyl urethane, or in an amount of 15 to 80% by weight of a subsequent epoxy component to be used, or in an amount of 15 to 60% by weight of a subsequent amine component to be used.

According to a second aspect of the invention, there is provided a paint, composite, potting compound, or adhesive product comprising the two-part epoxy resin composition in accordance with the first aspect of the invention.

According to a third aspect of the invention, there is provided a method of producing a modified hydroxy alkyl urethane suitable for use in a part A component of a two-part epoxy resin composition, the method comprising the steps of: a) preparing a hydroxy alkyl urethane having the formula:

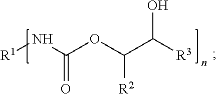

where: R¹ is an amine residue; and R² and R³ are the same or different and are selected from the group consisting of H, alkyl, and hydroxyalkyl; and b) reacting the hydroxy alkyl urethane with a (meth)acrylate monomer or oligomer to produce a modified hydroxy alkyl urethane.

Optionally, during step a], the hydroxy alkyl urethane may be prepared by reaction of a primary amine with a monocyclocarbonate.

The monocyclocarbonate may be selected from the group comprising: ethylene carbonate; 1,2-propylene carbonate; 1,2-butylene carbonate; 2,3-butylene carbonate, 1,2-pentylene carbonate; and 1,2-glycerol carbonate.

Preferably, the primary amine and monocyclocarbonate may be mixed in an equivalent weight ratio of between 1:1 and 1:1.1.

The primary amine may be selected from the group comprising: 2,2-(2,2,4)-trimethyl-1,6 hexanediamine; 1,6-hexanediamine; 2-methyl-1,5 pentanediamine; meta-xylene diamine; 1,3-dis (aminomethyl) cyclohexane; isophorone diamine; cyclohexane diamine; 4,4′-diaminodicyclohexyl-methane; polyoxypropylene diamines; polypropoxypropylene triamines; and phenalkamines with a ratio of between 1:3 and 1:4.

Optionally, the (meth)acrylate monomer or oligomer may be selected from the group comprising: 1,6-hexanediol di(meth)acrylate; tetraethylene di(meth)acrylate; triethylene di(meth)acrylate; tripropylene glycol di(meth)acrylate; dipropylene di(meth)acrylate; polyethylene glycol (600) dimethacrylate; tricyclodecanedimethanol di(meth)acrylate; propoxylated (2) neopentyl glycol di(meth)acrylate; pentaerythritol tetraacrylate; trimethylpropane tri(meth)acrylate; di-trimethylolpropane tetraacrylate; di-pentaerythritol pentaacrylate; pentaerythritol triacrylate; ethoxylated (3) trimethylolpropane triacrylate; propoxylated (3) trimethylolpropane triacrylate; ethoxylated (4) pentaerythritol tetraacrylate; propoxylated (3) glyceryl triacyrlate; epoxy acrylate; aliphatic urethane (meth)acrylate; aromatic urethane acrylate; polyester acrylate; multifunctional melamine acrylate; and aliphatic and silicone acrylate.

Preferably, the hydroxy alkyl urethane may be blended with the (meth)acrylate monomer or oligomer in the ratio of between 1:3 and 1:4.

The (meth)acrylate monomer or oligomer may comprise at least two terminal (meth)acrylate groups.

Optionally, the modified hydroxy alkyl urethane may be formed without any isocyanates or isocyanate-containing intermediates.

The (meth)acrylate monomer or oligomer may be introduced in an amount of 15 to 60% by weight of the hydroxy alkyl urethane.

According to a fourth aspect of the invention, there is provided a part A of an epoxy amine (meth)acrylate hydroxy urethane resin composition comprising: a modified hydroxy alkyl urethane; and an epoxy component; wherein the modified hydroxy alkyl urethane is formed by a reaction between a (meth)acrylate monomer or oligomer and a hydroxy alkyl urethane having the formula:

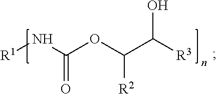

where: R¹ is an amine residue; and R² and R³ are the same or different and are selected from the group consisting of H, alkyl, and hydroxyalkyl.

A compound having this formula is a useful component of a curing compound for paints and adhesives, as well as being useful in composites and potting compounds, which results in a final composition which is both flexible and hard compared with existing compositions. There is the added benefit of eliminating the need for any bisphenol A or A/F ingredients which act as endocrine disruptors. This results in a much safer compound.

The invention will now be more particularly described, with reference to the indicative examples and embodiments outlined below.

### DETAILED DESCRIPTION

There is provided a resin composition comprising an epoxy acrylate resin with one or more (meth)acrylate monomers and/or oligomers. The epoxidized resin can be reacted with a hydroxyalkyl urethane amine via a Michael reaction, to yield an epoxy-amine-(meth)acrylate composition modified with a hydroxy alkyl urethane having the formula:

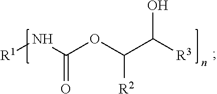

where R¹ is an amine residue. and R² and R³ are the same or different and are selected from the group consisting of H, alkyl, and hydroxyalkyl.

The composition is formed by reacting an epoxy acrylate resin on a hydroxyalkyl urethane via a Michael addition.

One example of a hydroxy alkyl urethane modifier, hereafter referred to as HUM-1, may be prepared as follows:

### HUM-1 Preparation

142 parts of 1,3-bis(aminomethyl) cyclohexane (1,3 BAC) are introduced into a reactor equipped with a stirring and a cooling system. Then, 224 parts of polypropylene carbonates are gradually introduced over 2 hours. The reaction is exothermic and requires cooling, with the reaction mixture being maintained at a temperature of 90° C. After 8 hours at 90° C., the amine index (MEQ/gram: 0.3) is checked. The reaction temperature is maintained at 100 to 120° C. until an amine index value of 0.15 is obtained. The final product has a dry extract of 96.4% (60 minutes at 100° C.) and the viscosity at room temperature is high. The viscosity at 50° C. is measured as 14 Pa·s. The consumption of the carbonate function is also measured by infra-red analysis (wavelength 1800 cm⁻¹) replaced by the urethane function.

To confirm the composition of the HUM-1 product, a sample was dispensed between two KBr plates to form a thin film. A transmission spectrum was recorded using a Thermo Scientific (RTM) Nicolet iS10 Fourier transform infra-red (FTIR) spectrometer.

A broad carbonyl absorption was detected at ˜1727 cm⁻¹ which is within the region expected for a carbonyl group as part of a urethane structure. It is also similar to than expected of an acrylate. A broad absorption was measured at ˜1100 cm⁻¹ which is indicative of the C—O bond in an aliphatic ether.

No indication of substantial free isocyanate was detected in the region of 2285 to 2275 cm⁻¹ in the recorded spectrum.

Another example of a hydroxy alkyl urethane modifier, hereafter referred to as HUM-2, may be prepared as follows:

### HUM-2 Preparation

170 parts of isophorone diamine are introduced into a reactor equipped with stirring and a cooling system. Then, 224 parts of propylene carbonate are gradually introduced over 2 hours. The reaction is exothermic and requires cooling, and the mixture is maintained at a temperature of 90° C. After 8 hours at 90° C., the amine index is checked (MEQ/gram: 0.3). The reaction temperature is maintained at 100-120° C. until an MEQ/gram value of 0.15 is obtained. The final product has a dry extract of 96.4% (60 minutes at 100° C.) and the viscosity at room temperature is very high.

It will be apparent that these examples of the production of hydroxy alkyl urethane modifier are indicative only, and can be any aminated hydroxy alkyl urethane modifier in accordance with the above formula.

Acrylated hydroxy alkyl urethane modifiers can then be produced by reaction with (meth)acrylate monomers or oligomers. This yields a compound having the generic formula of:

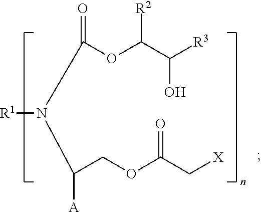

as the (meth)acrylate reacts with the amine group of the hydroxy alkyl urethane in a Michael addition reaction. Here:
A is H or an alkyl group;
X is a (meth)acrylate backbone residue;
R¹ is an amine residue; and
R² and R³ are the same or different and are selected from the group consisting of H, alkyl, and hydroxyalkyl.

The (meth)acrylates are provided in the form of monomers and oligomers. They are esters typically obtained by the reaction of a polyalcohol, a polyglycol and/or a mixture thereof on acrylic acid.

(meth)acrylates can be classified according to their functionality, that is by the repetition of the (meth)acrylate group within the monomer or oligomer, and by the nature of the (meth)acrylate backbone.

Examples of (meth)acrylates which can be used include: 1,6 haexanediol diacrylate (HDDA SR 238, from Sartomer (RTM)); polyethylene glycol 200 diacryalte; tetraethylene glycol diacrylate; triethylene glycol diacrylate; tripropylene glycol diacrylate (TPGDA SR 306 from Sartomer (RTM) 400); polyethylene glycol diacrylate; dipropylene glycol diacrylate; polyethylene glycol 600 diacrylate; tricyclodecanedimethanol diacrylate (SR 833S from Sartomer (RTM)); pentaerythritol tetraacrylate; trimethylolpropane triacrylate (Photmer 4006 from IGM Resins (RTM)); ethoxylated trimethylolpropane (20 EO) triacrylate; pentaerythritol triacrylate (SR 444D from Sartomer (RTM)).

Since the above list is non-exhaustive, it is noted that the following classifications of (meth)acrylate oligomers may be considered, according to their structure, including: epoxy (meth)acrylates; aliphatic urethane (meth)acrylates; aromatic urethane (meth)acrylates; polyurethane acrylate dispersions (such as UCECOAT from Allnex (RTM)); and polyester (meth)acrylates.

Examples of (meth)acrylated hydroxy alkyl urethane modifiers and their methods of production are provided below:

### HUMA-1 Preparation

100 g of HUM-2 based on isophorone diamine is blended with 300 g of trimethylol propane triacrylate (TMPTA—also known as SR351 from Sartomer). The reactants were put into a 1000 ml rector and the mixture stirred for one hour. The reaction mixture was kept at 40° C. with minimal agitation. When the mixture becomes clear and liquid, the temperature is decreased to 20-25° C., approximately room temperature. 50 ppm of 4-methoxyphenol (MEHQ) is then preferably added to stabilise the mixture. The epoxy equivalent weight (EEW) is determined as being 132, whilst the viscosity at 25° C. was 450-650 Pa·s.

### HUMA-2 Preparation

100 g of HUM-2 based on isophorone diamine is blended with 300 g of hexane diol diacrylate (HDDA—also known as SR238 from Sartomer). The reactants were put into a 1000 ml reactor and the mixture stirred for one hour. The reaction mixture was kept at 40° C. with minimal agitation. When the mixture becomes clear and liquid, the temperature is decreased to 20-25° C., approximately room temperature. 60 ppm of 4-methoxyphenol (MEHQ) is then preferably added to stabilise the mixture. The epoxy equivalent weight (EEW) is determined as being 150, whilst the viscosity at 25° C. was 250-350 Pa·s.

### HUMA-3 Preparation

100 g of HUM-2 based on isophorone diamine is blended with 300 g of tricyclodecanemethanol diacrylate (TCDDMDA—also known as Ebecryl 130 from Allnex). The reactants were put into a 1000 ml rector and the mixture stirred for one hour. The reaction mixture was kept at 40° C. with minimal agitation. When the mixture becomes clear and liquid, the temperature is decreased to 20-25° C., approximately room temperature. 65 ppm of 4-methoxyphenol (MEHQ) is then preferably added to stabilise the mixture. The epoxy equivalent weight (EEW) is determined as being 202, whilst the viscosity at 25° C. was 350-450 Pa·s.

This class of compounds is novel, and the process for their production does not generate isocyanates or isocyanate intermediates as is the case for urethane production known in the art.

This class of compounds can then be used to create epoxy amine hydroxy urethane compositions, as will be described hereafter.

Abbreviations and commercial names are provided below, which will be referred to in the subsequent description.

| | |
|---|---|
| DEGEBA | Diglycidyl ether of Bisphenol A (liquid 100%, epoxy resin) |
| DER 331 | DER 331 Olin Company, liquid 100%. epoxy resin DGEBA |
| DER 324 | DER 324 Olin Company, liquid epoxy resin(83% DGEBA + 17% C12-14 AGE |
| ARALDITE DY-C | Araldite DY-C Huntsman Company, diglycidyl ether cf cyclohexanedimethanol |
| EPOTECH RD 129 | EPOTECH RD 129, Aditya Chemicals, Pentarythritol polyglycidyl ether |
| ERYSIS G-61 | Erysis G-61 CVC Thermoset Specialities Scrpitol glycidyl Ether |
| HSF 2009 | HSF 2009 Cardolite Corporation, phenalkamine |
| VESTAMIN IPD | VESTAMIN IPD, Evonik Isophorone diamine |
| SR 351 | SR 351 Sartomer Company, Trimethylol Propane triacrylate |
| SR 238 | SR 238 Sartomer Company Hexane Diol Diacrylate |
| Ebecryl 130 | Ebecryl 130, Allnex, Tricyclodecanedimethanol diacrylate |
| EEW | Epoxy equivalent weight |
| AHEW | Amine hydrogen equivalent weight |

Firstly, six different epoxy amine hydroxy urethane compositions were created, using one of the base (meth)acrylated hydroxy alkyl urethane modifiers as hereto described. This is known as a part A compound in many contexts.

### Examples of Blended Epoxy Resin and HUMA Compound

| Example | Epoxy Resin | HUM/Acrylate | Blend | Viscosity | EEW |
|---|---|---|---|---|---|
| Ex1 | DER 331 | HUMA-1 | 60/40 | 900 Pa · s | 160 |
| Ex2 | Araldite DY-C | HUMA-1 | 60/40 | 350 Pa · s | 148 |
| Ex3 | Epotec RD 129 | HUMA-1 | 60/40 | 450 Pa · s | 148 |
| Ex4 | Araldite DY-C | HUMA-2 | 60/40 | 550 Pa · s | 155 |
| Ex5 | DER 324 | HUMA-3 | 80/20 | 550 Pa · s | 200 |
| Ex6 | Erysis G-61 | HUMA-1 | 60/40 | 900 Pa · s | 165 |

The viscosity was measured at 25° C. in accordance with the ASTM D 2196 method.

The blend of the relevant epoxy resin and the HUMA compound given in the table above at examples 1 to 6 was put into a vessel, and a hardener added, which comprised Cardolite HSF 2009 (AEHW: 57). This is often referred to as a part B compound. The mechanical and chemical properties of the resultant composition is outlined in table 1 below:

TABLE 1

| 100 parts of part A | Ex1 | Ex2 | Ex3 | Ex4 | Ex5 | Ex6 |
|---|---|---|---|---|---|---|
| Cardolite HSF 2009 Part B | 36 | 38 | 38 | 37 | 28 | 34 |
| Pot life, min | 45 | 60 | 35 | 120 | 30 | 60 |
| Hardness Shore D | 85 | 85 | 85 | 45 | 65 | 65 |
| Elongation at break % | 3 | 5 | 5 | 35 | 5 | 5 |
| Wear resistance | 25 | 25 | 25 | 23 | 21 | 23 |
| Weight gain at immersion in | 0.2 | 0.2 | 0.2 | 0.2 | 0.2 | 0.2 |
| water | | | | | | |
| Weight gain at immersion in | 0.2 | 0.2 | 0.2 | 0.2 | 0.2 | 0.2 |
| 20% H2SO4 | | | | | | |

Again, the viscosity was measured at 25° C. in accordance with the ASTM D 2196 method.

Three further epoxy amine hydroxy urethane compositions were created, using one of the base (meth)acrylated hydroxy alkyl urethane modifiers as hereto described.

### Examples of Blended Epoxy Resin and HUMA Compound

| Example | Epoxy Resin | HUM/Acrylate | Blend | Viscosity | EEW |
|---|---|---|---|---|---|
| Ex7 | DER 331 | HUMA-1 | 60/40 | 900 Pa · s | 160 |
| Ex8 | Araldite DY-C | HUMA-1 | 60/40 | 350 Pa · s | 148 |
| Ex9 | Epotec RD 129 | HUMA-1 | 60/40 | 450 Pa · s | 148 |

The blend of the relevant epoxy resin and the HUMA compound given in the table above at examples 7 to 8 was put into a vessel, and a hardener added, which comprised Vestamin IPD (AEHW: 43). This is often referred to as a part B compound. The mechanical and chemical properties of the resultant composition is outlined in table 1 below, following polymerization at 25° C.:

TABLE 2

| 100 parts of part A | Ex7 | Ex8 | Ex9 |
|---|---|---|---|
| Vestamin IPD Part B | 27 | 28 | 28 |
| Pot life, min | 120 | 150 | 45 |
| Hardness Shore D | 85 | 85 | 85 |
| Elongation at break % | 5 | 5 | 5 |
| Wear resistance | 21 | 23 | 25 |
| Weight gain at immersion in water | 0.2 | 0.2 | 0.2 |
| Weight gain at immersion in 20% H2SO4 | 0.2 | 0.2 | 0.2 |

The pot life has been calculated in accordance with the ASTM D1084 method, the Shore D hardness according to the ASTM D2240 method, the % elongation at break according to the ASTM D638 method, the abrasion resistance mg/1000 cycles according to the ASTM D4080 method, the weight gain in water immersion (24 hr at 25° C.) according to the ASTM D570 method, and the weight gain in immersion in a 20% H2SO4 solution (24 h at 25° C.) according to the ASTM D543 method.

It has been found that the substitution of the amines generally used as hardeners in an epoxy amine system with an amine of the hydroxy alkyl urethane amine type which reacts with a (meth)acrylate group via a Michael addition reaction on the C═C double bond allows the production of a final product which has a mechanical performance, chemical resistance and breaking strength which is superior to that of existing compositions.

Examples 1 to 9 demonstrate that epoxy amine (meth)acrylate modified using hydroxy alkyl urethane has improved curing properties, such as abrasion resistance, mechanical properties, and chemical resistance than those known in the art. This also advantageously provides an alternative to a DGEBA resin system which does not use bisphenol A or A/F or any endocrine disruptors.

Examples of epoxy resins which can be used in the present invention include those containing at least two glycidyl ether groups per molecule. These epoxy resins can be saturated or unsaturated, aliphatic, cyclo aliphatic or heterocyclic, and can be in the form of monomers or polymers.

A non-exhaustive list of potential epoxy resins is as follows: unmodified bisphenol A type epoxy resin (Epotec YD 126 from Aditya Birla Chemicals (RTM)); bisphenol F type epoxy resin (Epotec YD 170 from Aditya Birla Chemicals (RTM)); Resin Unmodified Bisphenol A/F (Epotec YDFM 256 Aditya Birla Chemicals (RTM)); or Bisphenol A/F resin diluted with a mono-functional diluent (Epotec YDFM 251 Aditya Birla Chemicals (RTM)).

A further non-exhaustive list of potential epoxy resins of polyglycidyl type on a vegetable base is also listed: Erisys G-60, G-61 on sorbitol base (CVC Thermoset specialties); Erisys isosorbide glycidyl ether on isosorbide base; (Erisys GE 38) polyglycerol 3 polyglycidyl ether; (Erysis GE 35) polyglycidyl ether based on castor oil; NC-514 (Cardolite) based on cashew nut shell liquid oil (CNSL).

The plant-based polyglycidyl ether resins reduce the carbon footprint and allow for the replacement of DGEBA-type diglycidyl ether resins containing Bisphenol A, F or A/F, which act as endocrine disruptors.

Depending on the use of the product, further additives may be considered, including, but not limited to: paints; varnishes; mineral fillers; pigments dyes; rheology additives; additives for improving film tension; additives for removing bubbles; additives and filters for improving UV resistance; coalescing agents; metal particulates; thickeners; flame retardants; anti-oxidants; metal primer; industrial coatings; stone carpet binder; sustainable urban drainage system binder; binder for terrazzo; sealants; roofing membrane; solvents, including water, to permit production of industrial floor paints, composite materials, adhesives, sealants, waterproofing membranes, floor coverings, including floor paints, mass filling such as potting compounds for the electrical sector, and so forth. The product is suitable for use on metal, concrete, composites, plastics, and wood, amongst other things.

The composition may be applied after mixing with a gravity spray gun, pressure pot system, airless spray system, or electrostatic spray system, for example, and using any appropriate applicator, including brushes, rollers, and pourers.

A viable formulation for a floor coating paint was created having the following formulation and characteristics:

Formulation 1

| Part A | Supplier | Composition |
|---|---|---|
| Exe2 | | 46.66 |
| Aktisil EM | Hoffman Mineral | 17.14 |
| Portaryte PB 10 | Sibelco | 22.85 |
| Tego Airex 944 | Evonik | 0.76 |
| TiO2 | Dupont | 11.46 |
| Bayferrox 318 | Lanxess | 1.13 |
| | | 100 |

| Part B | Supplier | Quantity |
|---|---|---|
| HSF 2009 | Cardolite | 18 |

It is noted that whilst Aktisil EM was used for the experimental data here, this compound is no longer commercially available; an equivalent chemical, Aktisil AM (Hoffman Mineral) can be acquired.

| | |
|---|---|
| Dry to touch (hour) | 4 |
| Pot life, min | 45 |
| Hardness Shore D | 85 |
| Elongation at break % | 5 |
| Wear resistance, loss of mass mg/1000 cycles | 21 |
| Weight gain at immersion in water (24 h at 25° C.)% | 0.2 |
| Weight gain at immersion in 20% H2SO4 (24 h at 25° C.)% | 0.2 |

A viable formulation for a high-performance coating (1 mm) was created having the following formulation and characteristics:

| Part A | Supplier | Composition |
|---|---|---|
| Ex3 | | 46.66 |
| Aktifit PF 111 | Hoffman Mineral | 17.14 |
| Portaryte PB 10 | Sibelco | 22.85 |
| Tego Airex 990 | Evonik | 0.76 |
| TiO2 | Dupont | 11.46 |
| Bayferrox 318 | Lanxess | 1.13 |
| | | 100 |

| Part B | Supplier | Quantity |
|---|---|---|
| HSF 2009 | Cardolite | 18 |

| | |
|---|---|
| Dry to touch (hour) | 2 |
| Pot life, min | 25 |
| Hardness Shore D | 87 |
| Elongation at break % | 3 |
| Wear resistance, loss of mass mg/1000 cycles | 18 |
| Weight gain at immersion in water (24 h at 25° C.)% | 0.1 |
| Weight gain at immersion in 20% H2SO4 (24 h at 25° C.)% | 0.1 |

In both of the examples provided here, the part B component of the two-part epoxy resin composition was provided as HSF 2009 (Cardolite), also known as 3-aminomethyl-3,5,5-trimethycyclohexamine, which is a phenalkamine curing agent. It will be appreciated, however, that the part A component of the two-part epoxy resin composition can be used with a wide range of potential curing agents comprising amine in the part B component, and the examples are therefore illustrative only.

It is therefore possible to provide a two-part epoxy resin composition which has improved curing properties, such as abrasion resistance, mechanical properties, and chemical resistance than those known in the art. The use of bisphenol A and A/F as uramine activator, which are endocrine disruptors can thus be avoided.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A two-part epoxy resin composition comprising:
a first resin part comprising a modified hydroxy alkyl urethane and an epoxy component; and
a second resin part comprising an amine component
wherein the modified hydroxy alkyl urethane is formed by a reaction between a (meth)acrylate monomer or oligomer and a hydroxy alkyl urethane having the formula:

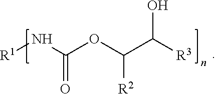

2. A two-part epoxy amine resin composition as claimed in claim 1, the (meth)acrylate monomer or oligomer has a (meth)acrylate backbone residue of a bi- or poly-(meth) acrylate.

3. A two-part epoxy resin composition as claimed in claim 1, wherein R¹ is selected from the group comprising: alkyl; cycloalkyl; alkylaryl; polyether; or oxyalkylene.

4. A two-part epoxy resin composition as claimed in claim 1, wherein the epoxy component comprises at least two terminal glycidyl groups.

5. A two-part epoxy resin composition as claimed in claim 1, wherein the modified hydroxy alkyl urethane has an epoxy equivalent weight of between 100 and 2000.

6. A two-part epoxy resin composition as claimed in claim 1, wherein the epoxy component is an epoxy resin or an epoxy with epoxy diluents.

7. A two-part epoxy resin composition as claimed in claim 1, wherein the epoxy component comprises an epoxy resin from the group: diglycidyl ether epoxy resin of bisphenol A; diglycidyl ether epoxy resin of bisphenol F; diglycidyl ether epoxy resin of bisphenol from cardanol; diglycidyl ether epoxy resin of hydrogenated bisphenol A; polyglycidyl ether resins; novolacs; hydrogenated novolacs; or any cycloaliphatic polyglycidyl ether resins; or combinations thereof.

8. A two-part epoxy resin composition as claimed in claim 1, wherein the epoxy component is a pentaerythritol polyglycidyl other.

9. A two-part epoxy resin composition as claimed in claim 1, wherein the amine component comprises an amine having an amine hydrogen equivalent weight, based on solids, of less than 150.

10. A paint, composite, potting compound, or adhesive product comprising the two-part epoxy resin composition as claimed in claim 1.

11. A method of producing a two-part epoxy resin composition, the method comprising the steps of:
a) preparing a hydroxy alkyl urethane having the formula: 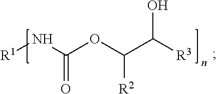
where:
R¹ is an amine residue; and
R² and R³ are the same or different and are selected from the group consisting of H, alkyl, and hydroxyalkyl;
b) reacting the hydroxy alkyl urethane with a (meth)acrylate monomer or oligomer to produce a modified hydroxy alkyl urethane; and
c) producing a two part epoxy resin composition comprising a first resin part comprising the modified hydroxy alkyl urethane and a second resin part which is a hardener.

12. A method as claimed in claim 11, wherein, during step a], the hydroxy alkyl urethane is prepared by reaction of a primary amine with a monocyclocarbonate.

13. A method as claimed in claim 12, wherein the monocyclocarbonate is selected from the group comprising: ethylene carbonate; 1,2-propylene carbonate; 1,2-butylene carbonate; 2,3-butylene carbonate, 1,2-pentylene carbonate; and 1,2-glycerol carbonate.

14. A method as claimed in claim 12, wherein the primary amine and monocyclocarbonate are mixed in an equivalent weight ratio of between 1:1 and 1:1.1.

15. A method as claimed in claim 12, wherein the primary amine is selected from the group comprising: 2,2,-(2,2,4)-trimethyl-1,6 hexanediamine; 1,6-hexanediamine; 2-methyl-1,5 pentanediamine; meta-xylene diamine; 1,3-bis(aminomethyl) cyclohexane; isophorone diamine; cyclohexane diamine; 4,4′-diaminodicyclohexyl-methane; polyoxypropylene diamines; and polypropoxypropylene triamines.

16. A method as claimed in claim 11, wherein the (meth)acrylate monomer or oligomer is selected from the group comprising: 1,6-hexanediol di(meth)acrylate; tetraethylene di(meth)acrylate; triethylene di(meth)acrylate; tripropylene glycol di(meth)acrylate; dipropylene di(meth)acrylate; polyethylene glycol (600) dimethacrylate; tricyclodecanedimethanol di(meth)acrylate; propoxylated (2) neopentyl glycol di(meth)acrylate; pentaerythritol tetraacrylate; trimethylpropane tri(meth)acrylate; di-trimethylolpropane tetraacrylate; di-pentaerythritol pentaacrylate; pentaerythritol triacrylate; ethoxylated (3) trimethylolpropane triacrylate; propoxylated (3) trimethylolpropane triacrylate; ethoxylated (4) pentaerythritol tetraacrylate; propoxylated (3) glyceryl triacyrlate; epoxy acrylate; aliphatic urethane (meth)acrylate; aromatic urethane acrylate; polyester acrylate; multifunctional melamine acrylate; and aliphatic and silicone acrylate.

17. A method as claimed in claim 16, wherein the hydroxyalkyl urethane is blended with the (meth)acrylate monomer or oligomer in the ratio of between 1:3 and 1:4.

18. A method as claimed in claim 11, wherein the (meth)acrylate monomer or oligomer comprises at least two terminal (meth)acrylate groups.

19. A method as claimed in claim 11, wherein the modified hydroxy alkyl urethane is formed without any isocyanates or isocyanate-containing intermediates.

20. A method as claimed in claim 11, wherein the (meth)acrylate monomer or oligomer is introduced in an amount of 15 to 60% by weight of the hydroxy alkyl urethane.

21. (canceled)
